(19) United States
(12) Patent Application Publication
(10) Pub. No.: US 2024/0194364 A1
(43) Pub. Date: Jun. 13, 2024

(54) ELECTROLYTIC INTERIOR SURFACE TREATMENT APPARATUS

(71) Applicants: C-Tech Innovation Limited, Chester (GB); National Nuclear Laboratory Limited, Warrington (GB)

(72) Inventors: Robert BELL, Chester (GB); John COLLINS, Chester (GB); Luke O'BRIEN, Warrington (GB)

(21) Appl. No.: 18/551,363

(22) PCT Filed: Mar. 21, 2022
(86) PCT No.: PCT/EP2022/057390

§ 371 Date: Sep. 19, 2023

(30) Foreign Application Priority Data
Mar. 19, 2021 (GB) 2103823.7

(51) Int. Cl. G21F 9/00; C25F 3/16; C25F 7/00; G21C 17/017

(52) U.S. Cl. CPC G21F 9/004; C25F 3/16; C25F 7/00; G21C 17/017

(57) ABSTRACT

Electrolytic interior surface treatment apparatus (100) for the electrolytic treatment of an internal surface (102) of a metallic pipe (1) includes at least two oppositely polarised electrodes (3, 4). The apparatus (100) includes: an electrically insulating centralisation arrangement (106) to keep, in use, the electrodes (3, 4) centred within the pipe (1); and an electrically insulating flexible connection arrangement (104) located between the two electrodes (3, 4) to permit movement of one electrode relative to the other. The centralisation arrangement (106) includes a plurality of spaced apart centralisation devices (5, 6). Each centralisation device (5, 6) includes an electrically insulating mounting (7) for mounting the respective centralisation device (5, 6) to the apparatus (100). Each centralisation device (5, 6) includes a plurality of flexible elements (108), each of which is fixed to the mounting (7) and extends outwardly from the mounting (7).

### BACKGROUND OF THE INVENTION

### 1. Field of the Invention

The present invention relates to electrolytic interior surface treatment apparatus, particularly but not exclusively, apparatus for the treatment of interior surfaces of pipework.

### 2. The Prior Art

The treatment of the interior surfaces of metal pipework by means of devices that pass along the pipe, often called pigs or pigging devices, is known. A variety of designs of pigging systems are available and used in petrochemical and chemical pipework. The devices incorporate a range of cleaning technologies including brushes and scrapers and in addition can include measurement devices and sensors. Pigging systems can be propelled through pipes by means of umbilical connections or by fluid pressure or by a self-contained power source.

The use of such devices for the electrochemical treatment of the interior of metallic pipework is also known. This process is sometimes known as electropolishing, and for such an application the device is fitted with one or more circular cross-section electrodes. An electric current flows from the device, through a conducting fluid or electrolyte within the pipe, and into the conducting metallic body of the pipe. Electrolytic action at the interior surface of the pipe causes dissolution of the surface of the metal and in this way the surface is treated. An example of such a technology is disclosed in U.S. Pat. No. 6,712,668 System and Method for Electropolishing. In order to achieve an even treatment around the interior circumference of the pipe, the electrode of circular cross-section must be kept central within the pipe. The interior surfaces of pipework used in the nuclear industry can become radioactively contaminated, and for the purposes of the decommissioning and removal of redundant pipework it is desirable to remove this contamination. Electrolytic cleaning or electropolishing is suited for this application, and would allow the removal of the radioactively contaminated internal layer of a metallic pipe by means of electrolytic dissolution. The contaminated material would be dissolved in the electrolyte and taken to a reprocessing facility in solution form. A number of requirements must be satisfied in order to make the application of electropolishing in the decontamination of radioactively contaminated pipework feasible.

A first requirement is that there must be a sufficient rate of treatment. The rate of treatment is limited by the amount of electrical current that passes through the electrolyte and into the pipe surface. This in turn is limited by the current density at the surface of the electrodes. If the current density is too high then excessive evolution of gasses occurs, and the process becomes inefficient. In addition, the electrode may be prone to deterioration at excessive current densities. The current density must therefore be kept below a certain limit. This requirement defines a minimum surface area of electrode to be used in order to give a satisfactory rate of treatment. For practical purposes this means that the maximum length of any rigid part of the electrode used to treat the interior surface of the pipe is limited by the need for the electrode to pass around bends in the pipe, without undue variation in the gap between the electrode and the pipe, and without the electrode touching the pipe.

The Applicant has realised that, to improve efficiency, it is desirable that the electric current path is predominantly between the electrodes via internal surfaces of the pipe and not conducted through the electrolyte fluid.

A further requirement is that the device be able to progress continuously along a liquid filled pipe which is sealed at one end, and that no part of the device form a seal to the passage of liquid around the device. Continuous movement is necessary for achieving an even electrochemical treatment at a sufficient rate of treatment.

A further requirement is that the device give an even treatment around the interior surface of the pipe. Electrochemical action varies as a function of the electrical resistance between the electrode and pipe surface and the resistance is lower when the electrode is closer to the pipe interior leading to a local increase in current. To achieve an even treatment a constant gap must be maintained between the electrode and the pipe surface, for those parts of the pipe free from raised welds or other surface variations.

An equivalent statement of this requirement is that the circular electrode must be maintained in the centre of the pipe. At the same time as maintaining this condition the device must be able to pass freely over inhomogeneities in the surface of the pipe, without the electrodes coming into contact with the pipe surface, and without requiring excessive force to move the device past the inhomogeneity. Inhomogeneities may include the raised surfaces of welds or variations in profile around valves or pipe joins.

A further requirement is that the device must also be able to move freely and smoothly both forwards and backwards. This is because in many applications it will be connected to a fixed access point by a flexible umbilical connection and must travel forwards and backwards to reach the treatment points and then to be recovered.

A further requirement is that the device is robust in use, including in pipes with internal diameters as small as 50 mm. This mitigates against the use of overly complicated mechanical arrangements with many linkages.

Existing designs do not simultaneously meet all of these requirements and are not suitable for the purpose. The problem with existing designs is that the known means of correctly locating the electrodes within the pipe do not allow the other requirements to be met. The use of guide wheels mounted on sprung carriers do not allow for effective operation.

For pipe diameters of 50 mm or so, and with the possibility of raised inhomogeneities in the surface of the pipe of 6 mm or so, the use of wheels as the primary means of locating the electrodes is impractical. The relatively large diameter of wheels relative to the internal diameter of the pipe that are needed to traverse the inhomogeneities, and the relatively low spring forces that are needed to ensure smooth passage over the inhomogeneities, mean that within the geometric constraints of the device the arrangement is not an effective means of locating the electrodes. It is not possible to achieve smooth passage over inhomogeneities at the same time as keeping the force required to move the device over those inhomogeneities sufficiently low. An additional drawback of this approach is that the complexity of the mechanical arrangement required reduces the robustness of the device in use. The use of flanges of various sorts is also not suitable for locating the electrodes within the pipe. Flanges that have sufficient flexibility to accommodate the size of inhomogeneities encountered are not able to accommodate reversals in the direction of travel of the device.

### SUMMARY OF THE INVENTION

According to a first aspect of the present invention, there is provided electrolytic interior surface treatment apparatus for the electrolytic treatment of an internal surface of a metallic pipe, the apparatus including at least two oppositely polarised electrodes, the apparatus being arranged so that, in use, there is no direct electrical contact between the apparatus and the internal surface being treated, the apparatus including:
an electrically insulating centralisation arrangement to keep, in use, the electrodes centred within the pipe;
an electrically insulating flexible connection arrangement located between the two electrodes to permit movement of one electrode relative to the other;
the centralisation arrangement including a plurality of spaced apart centralisation devices;
each centralisation device including an electrically insulating mounting for mounting the respective centralisation device to the apparatus;
each centralisation device including a plurality of flexible elements, each of which is fixed to the mounting and extends outwardly from the mounting.

Possibly, one centralisation device is mounted to, or at, or towards each end of the apparatus, and possibly, to or at, or towards each end of each electrode.

Possibly, the or each electrically insulating mounting extends over an end surface of the respective electrode, possibly substantially completely, to prevent current flow therethrough. Possibly, the or each mounting comprises a collar, an end piece or an end cap and the or each mounting may locate over, abut against or receive an end of the respective electrode.

Possibly, the flexible elements are radially spaced or evenly arranged around the mounting.

Possibly, each flexible element is formed of a resiliently deformable material and may be nonconductive or has high electrical resistivity.

Possibly, each flexible element is formed of a polymer, or carbon fibre reinforced polymer composite, or a glass fibre reinforced polymer composite.

Possibly, each flexible element is formed of a metallic material coated with an electrically insulating coating. The metallic material may be titanium or steel.

Possibly, the flexible elements are brush-like or spring-like. The apparatus may include both brush-like and spring-like flexible elements.

Possibly, in use, each flexible element exerts a spring force on the pipe. The spring force may be adjustable by changing linear compression on the respective flexible elements.

Possibly, each flexible element has a coating that reduces friction with the interior surface. Possibly, each flexible element has a coating that increases electrical resistance of the flexible element.

Possibly, each of the flexible elements is fixed at both ends, with the ends fixed to the same mounting or a different mounting.

Possibly, the apparatus includes one or more flexible electrically insulating resistive-barrier members. Each of the resistive-barrier members may be located between the oppositely polarised electrodes, possibly to increase the electrical resistance of the fluid path between the two oppositely polarised electrodes.

Possibly, the apparatus has a central axis. The or each resistive-barrier member may extend outwardly relative to the central axis.

Possibly, the diameter of the or each resistive-barrier member is larger than the diameter of the electrode and may be less than the diameter of the pipe.

Possibly, the or each resistive-barrier member substantially divides the interior of the pipe into separate spaces or pockets. Each space or pocket may have either no electrodes or may have one or more electrodes of only one polarity therein.

Possibly, the apparatus includes a barrier mounting for mounting the or each resistive-barrier member to the apparatus. Possibly, the or each barrier mounting comprises an electrically insulating material. Possibly, the or each barrier mounting is mounted to one of the electrodes. Possibly, the or each resistive-barrier member comprises a plurality of parts each of which is able to deform independently.

Possibly, the or each resistive-barrier member defines holes or perforations.

Possibly, the apparatus includes a pair of electrode assemblies. Each electrode assembly may comprise one electrode and a pair of the centralisation devices. Possibly, one centralisation device is located to, or at, or towards each end of the respective electrode.

Possibly, each electrode assembly includes a resistive-barrier member.

Possibly, the apparatus includes a plurality of each of the oppositely polarised electrodes, with a flexible connection arrangement between each electrode.

Possibly, one or each of the electrode assemblies comprises a plurality of segments which are linked by flexible connecting pieces. Possibly, one or more centralisation devices are located at intervals along the or each electrode assembly.

Possibly, in use, the electrodes are submerged within electrolyte liquid and may be located in a space which is substantially filled with electrolyte liquid. The space may comprise an interior of a metallic pipe.

According to a second aspect of the present invention, there is provided a method of electrolytically treating an interior surface, the method including providing electrolytic interior surface treatment apparatus for the electrolytic treatment of an internal surface of a metallic pipe, the apparatus including at least two oppositely polarised electrodes, the apparatus being arranged so that, in use, there is no direct electrical contact between the apparatus and the internal surface being treated, the apparatus including:
an electrically insulating centralisation arrangement to keep, in use, the electrodes centred within the pipe;
an electrically insulating flexible connection arrangement located between the two electrodes to permit movement of one electrode relative to the other;
the centralisation arrangement including a plurality of spaced apart centralisation devices;
each centralisation device including an electrically insulating mounting for mounting the respective centralisation device to the apparatus;
each centralisation device including a plurality of flexible elements, each of which is fixed to the mounting and extends outwardly from the mounting.

Possibly, the apparatus includes any of the features shown or described in any of the preceding statements, following description or accompanying drawings. Possibly, the method includes any of the steps shown or described in any of the preceding statements, following description or accompanying drawings.

### BRIEF DESCRIPTION OF THE DRAWINGS

Embodiments of the present invention will now be described, by way of example only, and with reference to the accompanying drawings, in which:

FIG. 1 is a schematic cross sectional side view of electrolytic interior surface treatment apparatus within a pipe;

FIG. 2 is a schematic cross sectional side view of an optional spacer unit in a pipe; and

FIG. 3 is a schematic cross sectional side view of another electrolytic interior surface treatment apparatus in a pipe.

In the drawings, where multiple instances of the same or similar features exist, only a representative one or some of the instances of the features may have been provided with numeric references for clarity.

### DETAILED DESCRIPTION OF THE PREFERRED EMBODIMENTS

The apparatus comprises two or more oppositely polarised electrodes of circular or other outer cross-section. This allows a system whereby an electric current is passed from a power supply to the apparatus, through the electrolyte liquid, into the pipe surface, along a short part of the pipe, back through the electrolyte and to a second and oppositely polarised electrode. This arrangement involves the surface being treated acting as both anode and cathode simultaneously, and is preferred over other arrangements because it does not require any direct electrical connection to be made to the pipe. This makes operation of the apparatus quicker and easier since it eliminates the requirement to make electrical connections to the pipe and check for the continuity of the electrical circuit along the pipe being treated, which may present difficulties for long pipe runs in inaccessible parts of a plant.

Each electrode is fitted with centralisation devices at either end, so that the electrode stays approximately in the centre of the pipe even when the pipe cross-section deviates from circularity. The centralisation devices comprise flexible strands or fibres or strips of electrically insulating material which collectively provide a centralising force, but individually can deform to pass smoothly over irregularities in the pipe surface. Suitable materials include polymers, glass-fibre reinforced polymers metals with an electrically insulating coating, and other composite materials. Depending on the choice of materials and number of elements, the centralisation devices may resemble annular brushes, or radially disposed flexible springs. The centralisation devices allow liquid to flow past them. The overall length of an electrode together with the centralisation devices is such that it can pass around the minimum bend radius required, whilst maintaining all points of the electrode at a suitable distance from the pipe interior surface.

Two or more electrode assemblies are connected together using articulated joints. The joints allow the equipment to flex as it passes round bends. More than two modules may be advantageous if it is required to reduce the treatment time or increase the amount of surface layer removed. The spacing between electrodes may be varied by including additional joints and spacing pieces between the electrodes.

The apparatus includes an umbilical connection which provides electrical power to the device. It may also serve as the motive force to move the apparatus along the pipe. It may also carry cabling for instrumentation.

The electrical supply for the electrolytic action is alternating current, so that there is no defined anode or cathode. The alternating current may be of a sinusoidal waveform, or it may be of another waveform best suited to maximise the electrolytic action.

In preferred embodiments, the apparatus could include electrically insulating resistive-barrier members located between oppositely polarised electrodes, which serve to increase the electrical resistance of the fluid path between the two electrodes, whilst not restricting fluid flow. This is achieved by reducing the cross sectional area of liquid through which current may flow from one electrode to another. The effect is to reduce the electrical losses that arise due to the passage of current directly from one electrode to the other through the solution, rather than through the pipe. These resistive-barrier members are of flexible insulating material and their flexibility is such that the resistive-barriers do not provide any significant positioning force for the apparatus, and they do not oppose the motion of the device forwards or backwards. Liquid can flow through and around the resistive-barrier members. Each resistive-barrier member may be composed of a single piece of flexible material or of multiple pieces of material and could define one or more holes or perforations.

Electrodes may be of rigid construction or optionally of flexible construction. Flexible electrodes may be required for small pipe bend radii. The electrode can be divided into multiple parts, each part connected to each other electrically, but with a degree of physical flexibility between the parts, achieved by means of flexible connecting pieces. Locating devices and flexible electrical resistive-barrier members are provided in the same manner as for rigid electrodes.

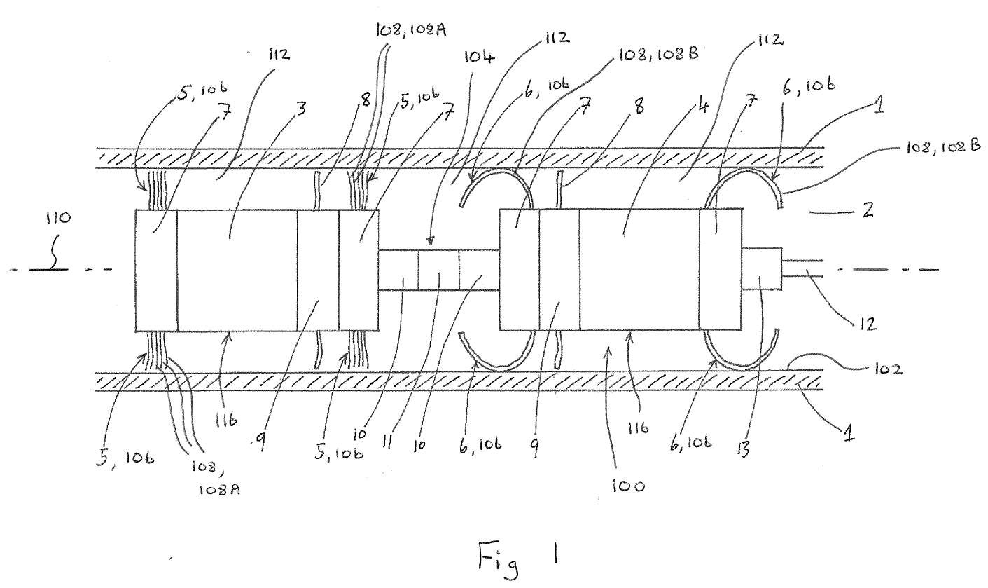

Referring to FIG. 1, electrolytic interior surface treatment apparatus 100 for the electrolytic treatment of an internal surface 102 of a metallic pipe 1 includes at least two oppositely polarised electrodes 3, 4. The apparatus 100 is arranged so that, in use, there is no direct electrical contact between the apparatus 100 and the internal surface 102 being treated.

The apparatus 100 includes: an electrically insulating centralisation arrangement 106 to keep, in use, the electrodes 3, 4 centred within the pipe 1; and an electrically insulating flexible connection arrangement 104 located between the two electrodes 3, 4 to permit movement of one electrode relative to the other.

The centralisation arrangement 106 includes a plurality of spaced apart centralisation devices 5, 6. Each centralisation device 5, 6 includes an electrically insulating mounting 7 for mounting the respective centralisation device 5, 6 to the apparatus 100.

Each centralisation device 5, 6 includes a plurality of flexible elements 108, each of which is fixed to the mounting 7 and extends outwardly from the mounting 7.

In the example shown, the electrodes 3, 4 are annular, of circular cross-section and are held central in the pipe 1 by the centralisation arrangement 106.

One centralisation device 5, 6 is mounted to, or at, or towards each end of the apparatus 100.

In the example shown, one centralisation device 5 is mounted at each end of one electrode 3 and one centralisation device 6 is mounted at each end of the other electrode 4.

Each of the electrically insulating mountings 7 extends over an end surface of the respective electrode 3, 4, to prevent current flow therethrough.

Each mounting 7 could comprise a collar, an end piece or an end cap. Each mounting 7 could locate over, abut against or receive an end of the respective electrode 3, 4.

The flexible elements 108 are radially evenly arranged around the mounting 7.

Each flexible element 108 is formed of a resiliently deformable material and is nonconductive or has high electrical resistivity.

Each flexible element 108 is formed of a polymer, or carbon fibre reinforced polymer composite, or a glass fibre reinforced polymer composite.

Alternatively, each flexible element 108 could be formed of a metallic material coated with an electrically insulating coating. The metallic material could be titanium or steel.

The flexible elements 108 could be brush-like or spring-like. The apparatus 100 could include both brush-like and spring-like flexible elements.

In use, each flexible element 108 could exert a spring force on the pipe 1. The spring force could be adjustable by changing linear compression on the respective flexible elements.

In the example shown, and for illustrative purposes, two different designs of centralisation devices 5, 6 are shown. In operation a single type of centralisation device, or a combination of types could be used.

One centralisation device 5 comprises a ring of short flexible brush-like elements, which could be strands or bristles. These elements radiate from an electrically insulating mounting 7, which secures them to the electrode 3.

The other centralisation device 6 comprises radially oriented flexible spring-like elements attached to an electrically insulating mounting 7, but in this case there are fewer elements, each with greater stiffness, and shaped so that they may pass easily in either direction over raised inhomogeneities or irregularities in the pipe surface.

Each flexible element 108 could have a coating that reduces friction with the interior surface 102. Each flexible element 102 could have a coating that increases electrical resistance of the flexible element.

Each of the flexible elements 108 could be fixed at both ends, with the ends fixed to the same mounting or a different mounting.

The apparatus 100 includes one or more flexible electrically insulating resistive-barrier members 8. Each of the resistive-barrier members 8 is located between the oppositely polarised electrodes 3, 4, to increase the electrical resistance of the fluid path between the two oppositely polarised electrodes.

The apparatus 100 has a central axis 110. The or each resistive-barrier member 8 extends outwardly relative to the central axis 110.

The diameter of the or each resistive-barrier member 8 is larger than the diameter of the electrodes 3, 4 and less than the diameter of the pipe 1. Each resistive barrier member 8 extends outwardly from the respective electrode towards the internal surface of the pipe, and could extend close to, and could contact the pipe, The size of the resistive-barrier member is arranged so that movement of the electrodes along the pipe is not prevented or substantially impeded.

The or each resistive-barrier member 8 substantially divides the interior of the pipe into separate spaces or pockets 112. Each space or pocket 112 has either no electrodes or one or more electrodes of only one polarity therein.

The apparatus 100 includes a barrier mounting 9 for mounting the or each resistive-barrier member 8 to the apparatus 100. The or each barrier mounting 9 comprises an electrically insulating material. The or each barrier mounting 9 is mounted to one of the electrodes 3, 4.

In the example shown, there are two sets of resistive-barriers 8 positioned between the two oppositely polarised electrodes.

In some embodiments, the or each resistive-barrier member 8 could comprise a plurality of parts each of which is able to deform independently.

In some embodiments, the or each resistive-barrier member 8 could define holes or perforations.

The apparatus 100 includes a pair of electrode assemblies 116. Each electrode assembly 116 comprises one electrode 3, 4 and a pair of the centralisation devices 5, 6. One centralisation device 5, 6 is located to, or at, or towards each end of the respective electrode 3, 4.

Each electrode assembly 116 includes a resistive-barrier member 8.

The apparatus 100 includes a plurality of each of the oppositely polarised electrodes 3, 4, with a flexible connection arrangement 104 between each electrode 3, 4.

The flexible connection arrangement 104 comprises connective elements 10 which connect the two electrode assemblies together via a flexible element 11. An umbilical cable 12 connects the apparatus to its source of power and is attached to the apparatus via a connecting piece 13. The umbilical cable also provides the force to move the apparatus along the pipe in the case illustrated.

In use, the apparatus 100 is located in the pipe 1 which is filled with conductive electrolyte liquid 2.

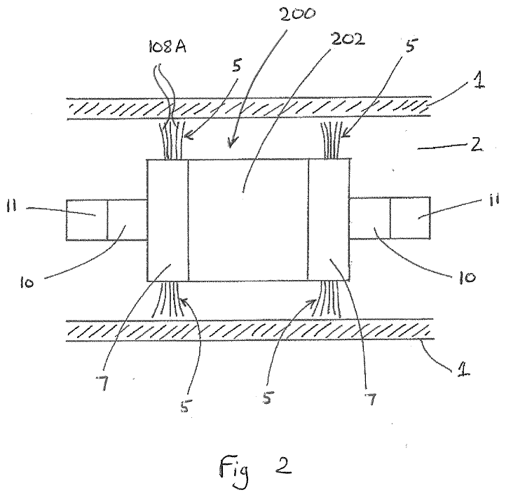

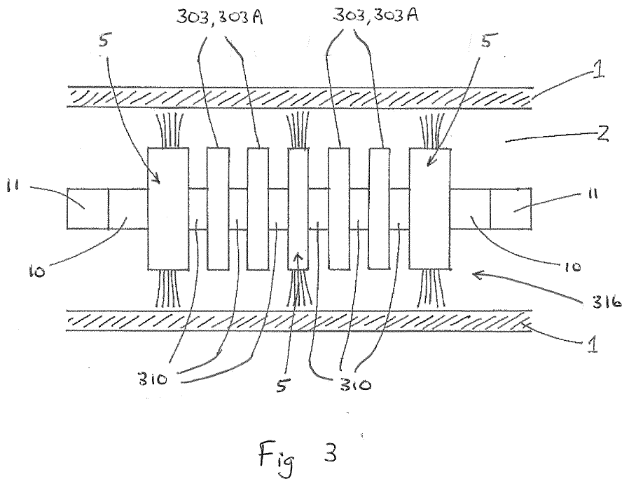

FIGS. 2 and 3 show other embodiments of the invention, many features of which are similar to those already described in relation to the embodiment of FIG. 1. Therefore, for the sake of brevity, the following embodiments will only be described in so far as they differ from the embodiment already described. Where features are the same or similar, the same reference numerals have been used for like parts and the features will not be described again.

FIG. 2 shows an optional spacer unit 200 that may be inserted between two electrode assemblies. The unit is shown in a pipe 1, filled with electrolyte liquid 2. The spacer unit is a means of increasing the electrical resistance of the fluid path between oppositely polarised electrodes. It may be used instead of, or in addition to, the electrical resistive-barriers 8 shown in FIG. 1. At either end of the spacer unit is a flexible coupling element 11 that connects to electrode assemblies. The flexible couplings are linked by connective elements 10 to the insulating mountings 7 of the flexible centralising devices 5. In this illustration brush-like centralising elements 108A are shown, although more spring like elements 108B of the type shown in FIG. 1 could alternatively be used. An electrically insulating spacer element 202 is sandwiched between the two centralising devices 5.

FIG. 3 shows an optional arrangement for a flexible electrode which may be useful for tight bend radii. In this embodiment, an electrode assembly 316 comprises an electrode 303 which comprises a plurality of electrode segments 303A which are linked by flexible connecting pieces 310. One or more centralisation devices 5 are located at intervals along the or each electrode assembly 316.

A pipe 1 is filled with electrolyte liquid 2. Centralising devices 5 are positioned at intervals, and sandwiching electrode segments 303A. The electrode segments 303A are electrically connected and form one electrode 303. Different numbers and arrangements of electrode segments, centralising devices, and flexible connecting pieces may be used, always provided that all electrode segments are electrically connected and so form a single electrode. At either end of the assembly are connective pieces 10, and flexible joints 11. Two or more such flexible electrodes can be connected together with other components in the same manner as is shown in FIG. 1.

Various other modifications could be made without departing from the scope of the invention. The apparatus and the various components thereof could be of any suitable size and shape, and could be formed of any suitable material (within the scope of the specific definitions herein).

Any of the features or steps of any of the embodiments shown or described could be combined in any suitable way, within the scope of the overall disclosure of this document.

There is thus provided electrolytic interior surface treatment apparatus with a number of advantages over conventional arrangements. The apparatus allows the interior surfaces of radioactively contaminated metal pipes, tubes or vessels to be treated, so that the risk involved in disposing of the pipework once it has been decommissioned is reduced. The treatment method is by means of electrochemical removal of the surface layer, and the invention is a means of controlling the positioning of the electrodes that are necessary for the electrochemical process. This invention maintains electrodes in the centre of the pipe even as the device passes around bends and over irregularities on the interior surfaces of the pipe, and allows the free movement of the device in either direction and within liquid filled pipes with closed ends and without requiring excessive force. Advantageously, the resistive-barrier members increase the efficiency of the apparatus by reducing conduction between the electrodes through the electrolyte liquid and ensuring that the electric current path is predominantly between the electrodes via internal surfaces of the pipe.

What is claimed is:

1. Electrolytic interior surface treatment apparatus for the electrolytic treatment of an internal surface of a metallic pipe, the apparatus including at least two oppositely polarised electrodes, the apparatus being arranged so that, in use, there is no direct electrical contact between the apparatus and the internal surface being treated, the apparatus including:
an electrically insulating centralisation arrangement to keep, in use, the electrodes centred within the pipe;
an electrically insulating flexible connection arrangement located between the two electrodes to permit movement of one electrode relative to the other;
the centralisation arrangement including a plurality of spaced apart centralisation devices;
each centralisation device including an electrically insulating mounting for mounting the respective centralisation device to the apparatus;
each centralisation device including a plurality of flexible elements, each of which is fixed to the mounting and extends outwardly from the mounting.

2. The apparatus according to claim 1, in which one centralisation device is mounted to, or at, or towards each end of the apparatus.

3. The apparatus according to claim 1, in which one centralisation device is mounted to, or at, or towards each end of each electrode.

4. (canceled)

5. The apparatus according to claim 1, in which the flexible elements are radially spaced or evenly arranged around the mounting.

6. The apparatus according to claim 1, in which each flexible element is formed of a resiliently deformable material.

7. The apparatus according to claim 1, in which each flexible element is nonconductive or has high electrical resistivity.

8. The apparatus according to claim 1, in which each flexible element is formed of a polymer, or carbon fibre reinforced polymer composite, or a glass fibre reinforced polymer composite, or a metallic material coated with an electrically insulating coating, and in which the metallic material may be titanium or steel.

9. The apparatus according to claim 1, in which the flexible elements are brush-like or spring-like.

10. The apparatus according to claim 9, in which the apparatus includes both brush-like and spring-like flexible elements.

11. The apparatus according to claim 1, in which, in use, each flexible element exerts a spring force on the pipe.

12-15. (canceled)

16. The apparatus according to claim 1, in which the apparatus includes one or more flexible electrically insulating resistive-barrier members, the or each of which is located between the oppositely polarised electrodes to increase the electrical resistance of the fluid path between the two oppositely polarised electrodes.

17. The apparatus according to claim 1, in which the apparatus includes one or more flexible electrically insulating resistive-barrier members; the apparatus has a central axis; and the or each resistive-barrier member extends outwardly relative to the central axis and in which the diameter of the or each resistive-barrier member is larger than the diameter of the electrode and less than the diameter of the pipe.

18. (canceled)

19. The apparatus according to claim 16, in which the or each resistive-barrier member substantially divides the interior of the pipe into separate spaces or pockets, with each space or pocket having either no electrodes or having one or more electrodes of only one polarity therein.

20. The apparatus according to any of claim 16, in which the apparatus includes a barrier mounting for mounting the or each resistive-barrier member to the apparatus.

21-22. (canceled)

23. The apparatus according to claim 16, in which the or each resistive-barrier member comprises a plurality of parts each of which is able to deform independently.

24. (canceled)

25. The apparatus according to claim 1, in which the apparatus includes a pair of electrode assemblies, each electrode assembly comprising one electrode and a pair of the centralisation devices, with one centralisation device located to, or at, or towards each end of the respective electrode.

26. The apparatus according to claim 25, in which each electrode assembly includes a resistive-barrier member.

27. The apparatus according to claim 1, in which the apparatus includes a plurality of each of the oppositely polarised electrodes, with a flexible connection arrangement between each electrode.

28. The apparatus according to claim 1, in which one or each of the electrode assemblies comprises a plurality of segments which are linked by flexible connecting pieces.

29. The apparatus according to claim 1, in which one or more centralisation devices are located at intervals along the or each electrode assembly.

30-31. (canceled)
